(19) United States
(12) Patent Application Publication
(10) Pub. No.: US 2015/0180387 A1
(43) Pub. Date: Jun. 25, 2015

(54) MOTOR CONTROLLER

(71) Applicants: HYUNDAI MOTOR COMPANY, Seoul (KR); Kia Motors Corporation, Seoul (KR)

(72) Inventors: Taeil YOO, Anyang-Si (KR); Han Hee PARK, Suwon-Si (KR)

(21) Appl. No.: 14/512,058

(22) Filed: Oct. 10, 2014

(30) Foreign Application Priority Data
Dec. 23, 2013 (KR) 10-2013-0161445

(51) Int. Cl. H02P 6/10; H02P 6/00

(52) U.S. Cl. CPC H02P 6/10; H02P 6/002

(57) ABSTRACT

A motor controller includes a variable controller, a current controller and an electric power module. The variable controller is configured to receive a torque command, a position of a rotor of a motor, and a motor rotation speed, change a first axis current command and a second axis current command according to variation of the position of the rotor of the motor, and output the first axis current command and the second axis current command. The current controller is configured to transform the first axis current command and second axis current command to a first axis voltage command and a second axis voltage command, respectively. The electric power module is configured to provide the first axis voltage command and second axis voltage command, modulated by pulse width modulation.

### CROSS-REFERENCE TO RELATED APPLICATION

This application claims benefit of priority to Korean Patent Application No. 10-2013-0161445 filed in the Korean Intellectual Property Office on Dec. 23, 2013, the entire contents of which are incorporated herein by reference.

### TECHNICAL FIELD

The present inventive concept relates to a motor controller. More particularly, the present inventive concept relates to a motor controller that can reduce a torque ripple in a vehicle using a motor as a driving source, such as an electric vehicle.

### BACKGROUND

To solve environmental pollution problems and to use alternative energy, an electric vehicle has been developed.

The electric vehicle includes a motor for driving the vehicle and a high voltage battery for supplying power to the motor. The battery is an energy source to drive the motor and can supply power to the motor through an inverter.

The inverter may convert a DC voltage into three-phase AC voltages (u-phase, v-phase, and w-phase) to provide the converted AC voltages to the motor through a power cable, and a motor controller may control the inverter through pulse width modulation (PWM).

In the electric vehicle, an output terminal of the motor is directly or indirectly connected to a driving unit of the vehicle, such that a driving torque of the motor influences driving of the vehicle. Therefore, a torque corresponding to a required torque command should be stably outputted, such that the vehicle using the motor as the driving source, such as an electric, vehicle is stably driven.

However, an unnecessary harmonic component such as a torque ripple may be outputted in addition to a required torque command due to structural nonlinearity of the motor and a characteristic of a motor controller. When the harmonic component is included in the output torque of the motor, a vibration may occur at a particular motor speed.

Further, when the vibration occurring in a driving system including the motor is diffused to the vehicle, ride comfort is deteriorated and durability of the vehicle is reduced.

The above information disclosed in this Background section is only for enhancement of understanding of the background of the inventive concept and therefore it may contain information that does not form the prior art that is already known.

### SUMMARY

The present inventive concept has been made in an effort to provide a motor controller that can reduce a torque ripple occurring in a vehicle using a motor as a driving source such as an electric vehicle.

One aspect of the present inventive concept relates to a motor controller including a variable controller, a current controller and an electric power module. The variable controller is configured to receive a torque command, a rotor position of a motor, and a motor rotation speed, change a first axis current command and a second axis current command according to variation of position of the rotor of the motor, and output the first axis current command and the second axis current command. The current controller is configured to transform the first axis current command and second axis current command to a first axis voltage command and a second axis voltage command, respectively. The electric power module is configured to provide the first axis voltage command and second axis voltage command, modulated by pulse width modulation.

The variable controller may include a torque controller and a variable maximum torque per ampere (MTPA) controller. The torque controller may be configured to calculate a modified rotor position of the motor from the rotor position of the motor and the motor rotation speed. The variable MTPA may be configured to output the first axis current command and the second axis current command corresponding to the modified rotor position of the motor.

The modified rotor position of the motor (θᵣ_{_{—}}_{mod}) may be calculated by an equation of θᵣ_{_{—}}_{mod}=α (θᵣ+β ωᵣ·dt)+θᵣ_{_{—}}_{offset}, and α and θᵣ_{_{—}}_{offset} are adjusting coefficients, β is a time delay correcting coefficient, θᵣ is a rotor position of the motor, and ωᵣ is a motor rotation speed.

α may converge to zero and θᵣ_{_{—}}_{offset} may converge to θᵣ when the torque controller is not used.

The variable MTPA controller may store MTPA information in a map table, and outputs the first axis current command and second axis current command corresponding to the modified rotor position of the motor and the torque command.

The variable MTPA controller may output the first axis current command and the second axis current command to cause a first axis current and a second axis current to flow through a motor coil of the motor and supply a first axis voltage and a second axis voltage to the motor to form a first magnetic flux and a second magnetic flux.

The variable MTPA controller may output the first axis current command and the second axis current command such that a combination of the first and second magnetic fluxes and the first and second axis currents is changed according to a change of two axis inductances of the motor.

The variable MTPA controller may output the first axis current command and the second axis current command such that a combination of the first and second axis currents to output an identical torque is changed according to the modified rotor position of the motor.

According to an aspect of the present inventive concept, since two axis currents and output of the MTPA controller are appropriately combined according to a rotor position of a motor, a torque ripple can be minimized.

### BRIEF DESCRIPTION OF THE DRAWINGS

The drawings are provided for reference in describing exemplary embodiments of the present inventive concept, and the spirit of the present inventive concept should not be construed only by the accompanying drawings.

FIG. 1 is a block diagram illustrating a motor controller according to an exemplary embodiment of the present inventive concept.

FIG. 2 is a graph illustrating a synchronous inductance according to a position of a rotor of a motor.

FIG. 3 is a graph illustrating a same torque curve according to a position of a rotor of a motor.

FIG. 4 is a graph illustrating an output torque according to a position of a rotor of a motor.

FIG. 5 shows graphs illustrating a torque and a motor speed according to a position of a rotor of a motor.

### DETAILED DESCRIPTION

The present inventive concept will be described more fully hereinafter with reference to the accompanying drawings, in which exemplary embodiments of the inventive concept are shown. As those skilled in the art would realize, the described embodiments may be modified in various different ways, all without departing from the spirit or scope of the present inventive concept.

In describing the present inventive concept, parts that are not related to the description will be omitted. Like reference numerals generally designate like elements throughout the specification.

In addition, the size and thickness of each configuration shown in the drawings are arbitrarily shown for better understanding and ease of description, but the present inventive concept is not limited thereto. In the drawings, the thickness of layers, films, panels, regions, etc., are exaggerated for clarity.

Hereinafter, a motor controller according to an exemplary embodiment of the present inventive concept will be described in detail with reference to accompanying drawings.

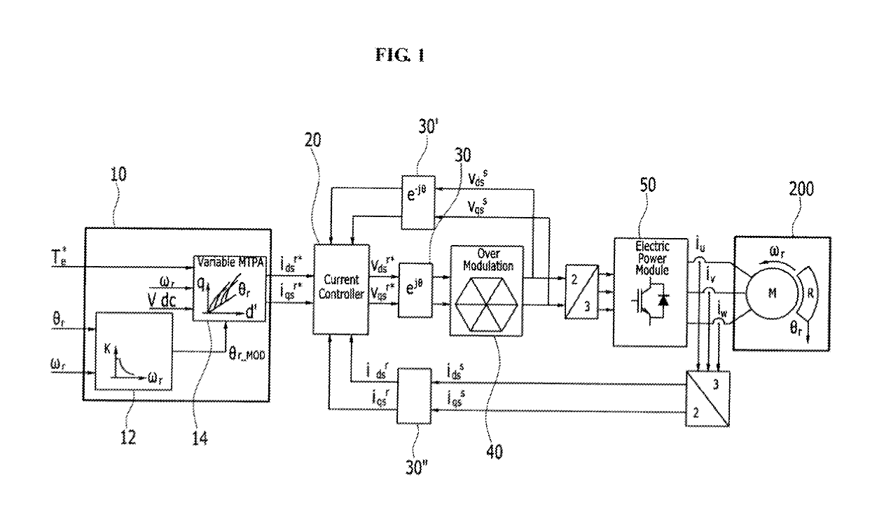

FIG. 1 is a block diagram illustrating a motor controller according to an exemplary embodiment of the present inventive concept.

As shown in FIG. 1, a motor controller according to an exemplary embodiment of the present inventive concept may include a variable controller, a current controller and an electric power module. The variable controller may output a current command in a synchronous reference frame from a torque command. The current controller may transform the current command to a voltage command in the synchronous reference frame. The electric power module may transform the voltage command to a PWM signal and outputting the PWM signal.

The variable controller may include a torque controller and a variable maximum torque per ampere (MTPA) controller. The torque controller may calculate a modified rotor position of the motor from a rotor position of the motor and a motor rotation speed. The variable MTPA controller may output the first axis current command and the second axis current command corresponding to the modified rotor position of the motor.

The torque controller may calculate the modified rotor position of the motor (θᵣ_{_{—}}_{mod}) from the motor rotation speed (ωᵣ) and the rotor position of the motor (θᵣ).

The modified rotor position of the motor (θᵣ_{_{—}}_{mod}) may be calculated from the following Equation 1.

θᵣ_{_{—}}_{mod}=α (θᵣ+β ωᵣ·dt)+θᵣ_{_{—}}_{offset} (Equation 1)

Here, α and θᵣ_{_{—}}_{offset} are adjusting coefficients, β is a time delay correcting coefficient, θᵣ is a rotor position of the motor, and ωᵣ is a motor rotation speed.

α and θᵣ_{_{—}}_{offset} are coefficients that adjust an operation level of the torque controller and whether the torque controller is operated. Generally, α may have a value of 1 and θᵣ_{_{—}}_{offset} may have a value of 0. However, a may converge to zero when the torque controller does not need to be used or the torque controller cannot be used. Further, θᵣ_{_{—}}_{offset} may converge to θᵣ. α may be greater than 1 or smaller than 1 according to the purpose of use.

β is a time delay correcting coefficient for correcting a rotor speed of the motor. β may be used to correct a time delay generated by the rotor speed of the motor. Generally, β may be 1, however the β may be greater than 1 or smaller than 1 according to the purpose of use.

When the rotor position of the motor (θᵣ) is supplied to the variable MTPA controller, a time delay (dt) may be generated. The time delay (dt) is a time difference from a time when the variable MTPA controller receives the rotor position of the motor (θᵣ) to a time when the motor torque is outputted. That is, dt is a time corresponding to a control period of the motor-inverter.

When the rotor position of the motor is changed during dt, an output error of the variable MTPA controller may occur according to the rotor position of the motor.

Therefore, the modified rotor position of the motor may be provided to the variable MTPA controller by using the torque controller.

The variable MTPA controller may receive the modified rotor position of the motor (θᵣ_{_{—}}_{mod}) outputted from the torque controller. The variable MTPA controller may store MTPA information changing in accordance with the modified rotor position of the motor (A and output a d-axis current command and a q-axis current command corresponding to the modified rotor position of the motor (θᵣ_{_{—}}_{mod}).

The MTPA information stored in the variable MTPA controller may be stored as a map table or an equation including a polynomial expression.

As such, since the d-axis current command and the q-axis current command corresponding to the modified rotor position of the motor are outputted, a motor output torque can be uniformly maintained.

The current controller may receive the d-axis current command and the q-axis current command outputted from the variable MTPA controller. The current controller may output a d-axis voltage command and a q-axis voltage command by transforming the d-axis current command and the q-axis current command.

The d-axis voltage command and the q-axis voltage command may be coordinate-transformed by a coordinate transformer, and an electric power module 50 may receive the d-axis voltage command and the q-axis voltage command after overmodulation by a modulator.

The electric power module may output the d-axis voltage command and the q-axis voltage command after pulse width modulating the d-axis voltage command and the q-axis voltage command.

A torque command (Tₑ*) inputted to the motor controller and an output torque (Te) outputted from the motor may have a relationship of the following Equation 2.

$${Te}^{*} ≅ Te = \frac{3}{2} \cdot \frac{P}{2} \cdot ( {I}_{qs}^{r} \cdot dFlux - {I}_{ds}^{r} \cdot qFlux ) \qquad ( Equation 2 )$$

Here, P is a number of motor poles, I_{ds}^{r} is a d-axis current, I_{qs}^{r} is a q-axis current, dFlux is a d-axis magnetic flux, and qFlux is a q-axis magnetic flux.

The d-axis voltage command and the q-axis voltage command (V_{ds}^{r*}, V_{qs}^{r*}) may have a relationship of the following Equation 3.

$$\begin{matrix}{v}_{ds}^{r *} = {v}_{dfb}^{r} + {v}_{dff}^{r} \\ = \frac{{sK}_{pd} + {K}_{id}}{s} Δ {i}_{ds}^{r} - \frac{{K}_{ad} {K}_{id}}{s} Δ {v}_{ds}^{r} + {ω}_{r} \cdot {\hat{L}}_{q} {i}_{qs}^{r}\end{matrix} \\ \begin{matrix}{v}_{qs}^{r *} = {v}_{qfb}^{r} + {v}_{qff}^{r} \\ = \frac{{sK}_{pq} + {K}_{iq}}{s} Δ {i}_{qs}^{r} - \frac{{K}_{aq} {K}_{iq}}{s} Δ {v}_{qs}^{r} + \\ {ω}_{r} ( {\hat{L}}_{q} {i}_{ds}^{r} + {\hat{λ}}_{f} )\end{matrix} \\ where , \\ \begin{matrix}Δ {i}_{ds}^{r} = {i}_{ds}^{r *} - {i}_{ds}^{r} , Δ {i}_{qs}^{r} \\ = {i}_{qs}^{r *} - {i}_{qs}^{r} , Δ {v}_{ds}^{r} \\ = {v}_{ds}^{r *} - {v}_{ds}^{r} , Δ {v}_{qs}^{r} \\ = {v}_{qs}^{r *} - {v}_{qs}^{r *}\end{matrix} \qquad \{ Equation 3 )$$

Here, V_{dfb}^{r} is a d-axis feedback voltage of the output terminal, V_{dff}^{r} is a d-axis feed-forward voltage of the output terminal, V_{qfb}^{r} is a q-axis feedback voltage of the output terminal, V_{qff}^{r} is a q-axis feed-forward voltage of the output terminal, K_{pd}, K_{id}, and K_{ad} are d-axis gains, K_{pq}, K_{iq}, and K_{aq} are q-axis gains, L_{d} is a d-axis estimated inductance, L_{q} is a q-axis estimated inductance, and λ_{f} is an estimated permanent flux linkage.

That is, the d-axis voltage command (V_{ds}^{r*}) is the sum of the feedback voltage (V_{dfb}^{r}) of the output terminal of a PI (proportional integral) controller and the feed-forward voltage (V_{dff}^{r}) for decoupling. The q-axis voltage command (V_{qs}^{r*}) is the sum of the feedback voltage (V_{qfb}^{r}) of the output terminal of the PI controller and the feed-forward voltage (V_{qff}^{r}) for decoupling.

Two axis currents (I_{ds}^{r}, I_{qs}^{r}) flowing through the motor coil and two axis voltages (V_{ds}^{r}, V_{qs}^{r}) supplying the motor may form magnetic fluxes (dFlux, qFlux) by electric interrelation. A steady state relationship of the three-phase motor may be as in the following Equation 4.

$$\begin{matrix}\begin{matrix}dFlux = ( {V}_{qs}^{r} - {R}_{s} \cdot {i}_{qs}^{r} ) \cdot \frac{1}{{ω}_{r}} \\ = [ \frac{{sK}_{pq} + {K}_{iq}}{s} Δ {i}_{qs}^{r} - \frac{{K}_{aq} {K}_{iq}}{s} Δ {v}_{qs}^{r} ] \cdot \frac{1}{{ω}_{r}} + \\ ( {\hat{L}}_{d} {i}_{ds}^{r} + {\hat{λ}}_{f} ) - {R}_{s} \cdot {i}_{qs}^{r} \cdot \frac{1}{{ω}_{r}}\end{matrix} & \{ Equation 4 ) \\ \begin{matrix}dFlux = ( - {V}_{ds}^{r} - {R}_{s} \cdot {i}_{ds}^{r} ) \cdot \frac{1}{{ω}_{r}} \\ = - [ \frac{{sK}_{pd} + {K}_{id}}{s} Δ {i}_{ds}^{r} - \frac{{K}_{ad} {K}_{id}}{s} Δ {v}_{ds}^{r} ] \cdot \frac{1}{{ω}_{r}} + \\ {\hat{L}}_{q} {i}_{qs}^{r} + {R}_{s} \cdot {i}_{ds}^{r} \cdot \frac{1}{{ω}_{r}}\end{matrix} & \end{matrix}$$

The two axis voltages (V_{ds}^{r}, V_{qs}^{r}) may include estimated values of two inductances (L_{d}, L_{q}) formed when the two axis currents (I_{ds}^{r}, I_{qs}^{r}) flow. When the estimated values of the two inductances (L_{d}, L_{q}) included in the two axis voltages (V_{ds}^{r}, V_{qs}^{r}) are different from two axis inductances of a real motor or when the estimated values of the two inductances (L_{d}, L_{q}) do not appropriately follow a variation of real inductance, the two axis voltages (V_{ds}^{r}, V_{qs}^{r}) supplied by a motor and an invert system cannot make a desired combination of magnetic fluxes (dFlux, qFlux).

When a combination of two required axis currents (I_{ds}^{r}, I_{qs}^{r}) and magnetic fluxes (dFlux, qFlux) is not formed, unrequired torque (Tₑₑᵣᵣₒᵣ) may be generated in addition to the required torque (Tₑ*) as described in the following Equation 5 and Equation 6. When an error of estimated inductance and real inductance is periodically repeated, an output torque may periodically vibrate. Accordingly, a vibration of the motor may occur.

$$\begin{matrix}{\hat{L}}_{d} = {L}_{d - real} + {L}_{d - error} & \{ Equation 5 ) \\ {\hat{L}}_{q} = {L}_{q - real} + {L}_{q - error} & \\ \begin{matrix}dFlux = [ \frac{{sK}_{pq} + {K}_{iq}}{s} Δ {i}_{ds}^{r} - \frac{{K}_{aq} + {K}_{iq}}{s} Δ {v}_{ds}^{r} ] \cdot \frac{1}{{ω}_{r}} + \\ \{ ( {L}_{d \_ real} + {L}_{d \_ error} ) \cdot {i}_{ds}^{r} + {\hat{λ}}_{f} \} - {R}_{s} \cdot {i}_{qs}^{r} \cdot \frac{1}{{ω}_{r}} \\ = {dFlux}_{actual} + {dFlux}_{error}\end{matrix} & \\ \begin{matrix}qFlux = [ \frac{{sK}_{pd} + {K}_{id}}{s} Δ {i}_{ds}^{r} - \frac{{K}_{ad} + {K}_{id}}{s} Δ {v}_{ds}^{r} ] \cdot \frac{1}{{ω}_{r}} + \\ ( {L}_{q \_ real} + {L}_{q \_ error} ) \cdot {i}_{qs}^{r} + {R}_{s} \cdot {i}_{ds}^{r} \cdot \frac{1}{{ω}_{r}} \\ = {qFlux}_{actual} + {qFlux}_{error}\end{matrix} & \\ \begin{matrix}Te = \frac{3}{2} \cdot \frac{P}{2} \cdot \{ {I}_{qs}^{r} \cdot ( {dFlux}_{actual} + {dFlux}_{error} ) - {I}_{ds}^{r} \cdot \\ ( {qFlux}_{actual} + {qFlux}_{error} ) \} \\ = \frac{3}{2} \cdot \frac{P}{2} \cdot \{ ( {I}_{qs}^{r} \cdot {dFlux}_{actual} - {I}_{ds}^{r} \cdot {qFlux}_{actual} ) + \\ ( {I}_{qs}^{r} \cdot {dFlux}_{error} - {I}_{ds}^{r} \cdot {qFlux}_{error} ) \} \\ = {Te}^{*} + {Te}_{error}\end{matrix} & \{ Equation 6 )\end{matrix}$$

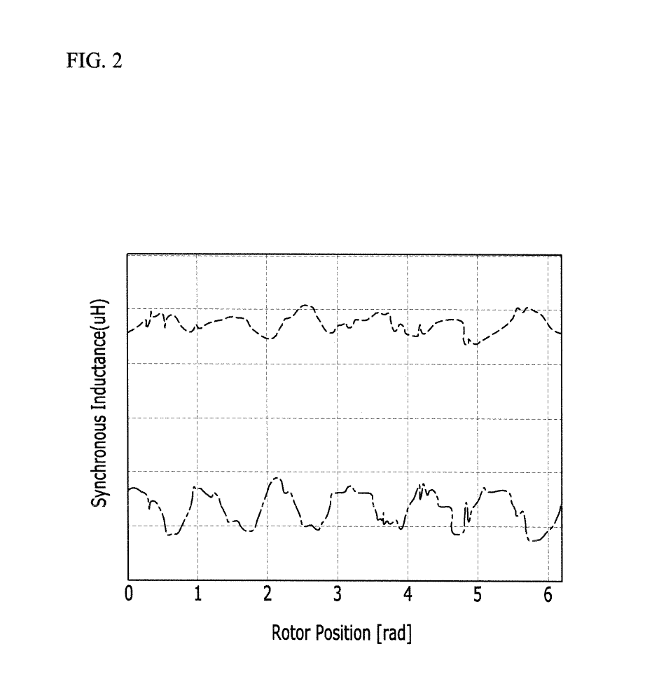

FIG. 2 is a graph illustrating a synchronous inductance according to a position of a rotor of a motor.

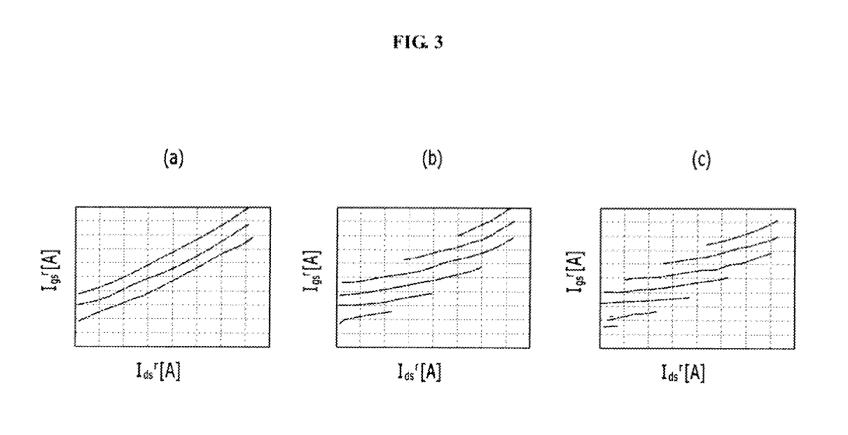

When two axis voltages (V_{ds}^{r}, V_{qs}^{r}) outputted from the current controller, as shown in FIG. 3, do not follow two axis inductances in real time, or when magnetic fluxes (dFlux, qFlux) do not uniformly form according to the rotor position of the motor, the combination of two axis current commands (I_{ds}^{r*}, I_{qs}^{r*}) does not output the same torque according to the rotor position of the motor. Therefore, in order to output the same torque, the combination of the magnetic fluxes (dFlux, qFlux) and two axis currents (I_{ds}^{r}, I_{qs}^{r}) may be changed according to a change of the two axis inductances.

FIG. 3 is a graph illustrating a same torque curve according to a position of a rotor of a motor. FIG. 3 (a) is a same torque curve when a rotor of a motor is positioned at 0.5 rad from a reference position. FIG. 3 (b) is a same torque curve when a rotor of a motor is positioned at 1.2 rad from a reference position. FIG. 3 (c) is a same torque curve when a rotor of a motor is positioned at 2.1 rad from a reference position.

As shown in FIG. 3, the combination of two axis currents (I_{ds}^{r}, I_{qs}^{r}) to output the same torque may be changed according to the rotor position of the motor.

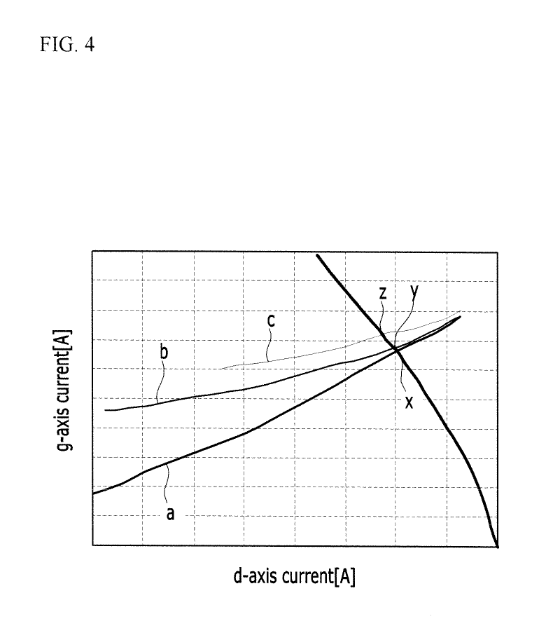

FIG. 4 is a graph illustrating an output torque according to a position of a rotor of a motor. That is, FIG. 4 illustrates a curve corresponding to a specific torque in the same torque curves of FIG. 3 (a) to (c).

As shown in FIG. 4, when the rotor of the motor is positioned at 0.5 rad, 1.2 rad, and 2.1 rad from the reference position, the same torque curve is changed such as a line a, a line b, and a line c. Also, the combination of two axis currents (I_{ds}^{r}, I_{qs}^{r}) to output the same torque is changed such as a point x, a point y, and a point z.

Thus, in an exemplary embodiment of the present inventive concept, the current command may be changed according to the rotor position of the motor.

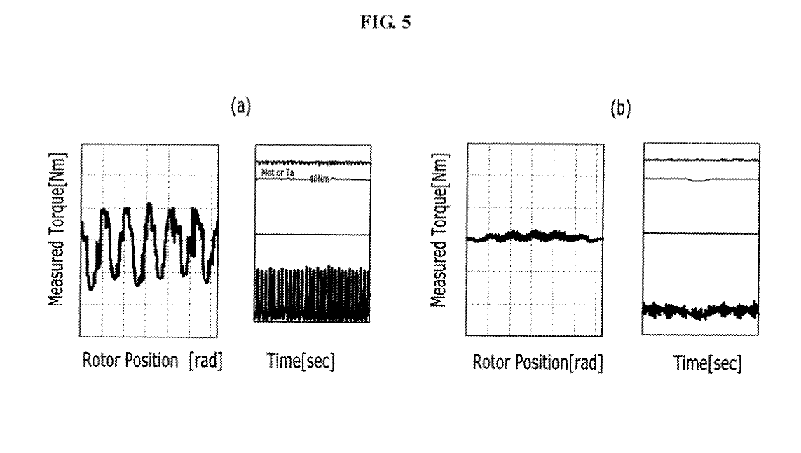

FIG. 5 is a graph illustrating a torque and a motor speed according to a position of a rotor of a motor. FIG. 5 (a) shows torque and RPM of a motor according to the prior art, and FIG. 5 (b) shows torque and RPM of a motor according to the present inventive concept.

As shown in FIG. 5, in the prior art, a measuring torque severely pulsates according to the rotor position of the motor. Accordingly, the motor speed fluctuates. However, in an exemplary embodiment of the present inventive concept, a pulsation of torque may be reduced according to the rotor position of the motor. Accordingly, the motor speed may be uniformly maintained.

As described above, as in an exemplary embodiment of the present inventive concept, a torque ripple of the motor can be controlled according to the rotor position of the motor.

While this inventive concept has been described in connection with what is presently considered to be practical exemplary embodiments, it is to be understood that the inventive concept is not limited to the disclosed embodiments, but on the contrary, is intended to cover various modifications and equivalent arrangements included within the spirit and scope of the appended claims.

1. A motor controller, comprising:
a variable controller configured to receive a torque command, a position of a rotor of a motor, and a motor rotation speed, change a first axis current command and a second axis current command according to variation of the position of the rotor of the motor, and output the first axis current command and the second axis current command;
a current controller configured to transform the first axis current command and the second axis current command to a first axis voltage command and a second axis voltage command, respectively; and
an electric power module configured to provide the first axis voltage command and the second axis voltage command, modulated by pulse width modulation.

2. The motor controller of claim 1, wherein the variable controller comprises:
a torque controller configured to calculate a modified position of the rotor of the motor from the position of the rotor of the motor and the motor rotation speed; and
a variable MTPA controller configured to output the first axis current command and the second axis current command corresponding to the modified position of of the rotor of the motor.

3. The motor controller of claim 2, wherein:
the modified position of of the rotor of the motor is calculated by an equation of θᵣ_{_{—}}_{mod}=α (θᵣ+β ωᵣ·dt)+θᵣ_{_{—}}_{offset}, and
α and θᵣ_{_{—}}_{offset} are adjusting coefficients, β is a time delay correcting coefficient, θᵣ is a rotor position of the motor, and ωᵣ is a motor rotation speed.

4. The motor controller of claim 3, wherein α converges to zero and θᵣ_{_{—}}_{offset} converges to the θᵣ when the torque controller is not used.

5. The motor controller of claim 2, wherein the variable MTPA controller is configured to store MTPA information in a map table and output the first axis current command and second axis current command corresponding to the modified position of the rotor of the motor and the torque command.

6. The motor controller of claim 2, wherein the variable MTPA controller is configured to output the first axis current command and the second axis current command to cause a first axis current and a second axis current to flow through a motor coil of the motor and supply a first axis voltage and a second axis voltage to the motor to form a first magnetic flux and a second magnetic flux.

7. The motor controller of claim 6, wherein the variable MTPA controller is configured to output the first axis current command and the second axis current command such that a combination of the first and second magnetic fluxes and the first and second axis currents is changed according to a change of two axis inductances of the motor.

8. The motor controller of claim 6, wherein the variable mtpa controller is configured to output the first axis current command and the second axis current command such that a combination of the first and second axis currents to output an identical torque is changed according to the modified position of the rotor of the motor.
